(19) United States
(12) Patent Application Publication
(10) Pub. No.: US 2014/0342791 A1
(43) Pub. Date: Nov. 20, 2014

(54) INTERACTIVE ELECTRONIC GAME OF PATTERN MATCHING

(71) Applicant: REKKENER LLC, Los Angeles, CA (US)

(72) Inventors: Harlan HUGH, Los Angeles, CA (US); Kevin VALERIANO, Edmonton (CA)

(73) Assignee: REKKENER LLC, Los Angeles, CA (US)

(21) Appl. No.: 14/230,517

(22) Filed: Mar. 31, 2014

Related U.S. Application Data
(60) Provisional application No. 61/853,154, filed on Mar. 29, 2013.

(51) Int. Cl. A63F 13/40

(52) U.S. Cl. CPC A63F 13/10
USPC 463/9

(57) ABSTRACT

A method of playing an interactive game of pattern matching. The game application renders an image of a target pattern of items in a designated area of the display screen and an array of items in a stack area of the display screen. The player selects a pattern corresponding to a group of items in the stack area. If the selected pattern matches at least part of the target pattern, the selected pattern is removed from the stack area, and if it does not match, the items of the selected pattern are kept within the stack area. A match is determined when the items in the selected pattern match corresponding items in the at least part of the target pattern. After an item has been removed, a space is left behind in the stack, which allows another item in the stack from above the space to drop into the space after previous item has been removed.

### PRIORITY CLAIM

This application claims the priority of U.S. Provisional Patent Application No. 61/853,154 filed on Mar. 29, 2013. This application is fully incorporated by reference as if fully set forth herein. All publications noted below are fully incorporated by reference as if fully set forth herein.

### BACKGROUND OF THE INVENTION

1. Field of the Invention

The present application relates to interactive gaming on an electronic device, and more particularly to electronic games playable using an electronic device having a display rendering the gameplay sequence.

2. Description of Related Art

The rising popularity of mobile devices for playing games has created a demand for simple games that can be played for short periods of time while providing a sense of accomplishment and pleasure through mental stimulation associated with pattern matching.

Amongst the most popular of these types of games are titles known as “Match 3” games such as “Bejeweled” and “Candy Crush Saga”. In Match 3 games, the player must find 2 items of the same type near to one another in a grid of randomly arranged items where a third item of that same type can be slid over to form a line of three or more matching items. With millions of these games played every day, they represent a significant form of entertainment. However, these and other titles utilize a fundamentally identical gameplay mechanic and struggle to offer something novel to players.

Other games, such as those presented in IQ tests ask the player to match a pattern to another pattern in a multiple-choice format. This type of gameplay however is limited to a selection from a pre-determined list and offers very little interactivity. Also, this type of pattern matching typically requires the patterns to be created beforehand by an author and cannot be easily extended by randomly generated input from a computer.

There is a need for a gameplay mechanic that is fun and easy to understand while offering a new type of activity for players.

### SUMMARY OF THE INVENTION

The present invention provides an interactive electronic game of pattern matching, which will keep a player engaged in the game with challenging gameplay and variations.

In one aspect, the present invention provides a game device and a method of playing an interactive game of pattern matching deployed in the game device. The game application renders an image of a target pattern of items in a designated area of the display screen and an array of items in a stack area of the display screen in accordance with the game application, wherein the items are of at least two types. A player selects a pattern corresponding to a group of items in the stack area (e.g., the array of items in the stack area is arranged in staggered parallel rows). If the selected pattern matches at least part of the target pattern, the group of items of the selected pattern is removed from the stack area, and if a match is not determined, the items of the selected pattern are kept within the stack area. In one embodiment, a match is determined when the items in the selected pattern match corresponding items in at least part of the target pattern. More specifically, a match is determined if the type and orientation of the items in the selected pattern match the corresponding items in the at least part of the target pattern.

After an item has been removed, a space is left behind in the stack, which allows another item in the stack from above the space to drop into the space after the previous item has been removed. Further, the array of items in the stack area may not completely fill the entire stack area, thus allowing the player to selectively manipulate (e.g., by a dragging motion) an item into a space not filled with item. The target pattern may be rotated to change its orientation. Tiles may be provided to present a barrier against movement of the items in the stack area. Some of the tiles may be activated to effect movement of items adjacent to said tile.

The items are represented by graphics, which can be customized by the player. Similarly, the background image can be customized by a player.

In another aspect of the invention, the game application includes a multiplayer mode, in which more than one player can play the game in cooperative play or competitive play. A first player selects a first pattern corresponding to a first group of items in the stack area, and a second player selects a second pattern corresponding to a second group of items in the stack area. In one embodiment, the first player selects the first pattern and the second player selects the second pattern using the same or different game device. If different game device, they may depict the same target pattern and same stack area, or the same starting target pattern and same starting stack area, wherein action by the first player may or may not affect the stack area depicted at the second game device, and vice versa.

More than one game device may communicate via a network.

### BRIEF DESCRIPTION OF THE DRAWINGS

FIG. 1 is a schematic representation of a screen image of the game area depicted on the display of a game device, in accordance with one embodiment of the present invention.

FIG. 2 is a schematic flow diagram illustrating the basic steps in the inventive game, in accordance with one embodiment of the present invention.

FIG. 3 illustrates examples of matching of the pattern of selected groups of items to the target pattern.

FIG. 4 illustrates the sequence of selecting and removing items from the stack area.

FIG. 5 illustrates rotation of the target pattern.

FIG. 6 illustrates strategic manipulation of items in the stack area, in accordance with one embodiment of the present invention.

FIG. 7 illustrates additional manipulation of items in relation to tiles in the stack area.

FIG. 8 illustrates various additional manipulation of item in the stack area.

FIG. 9 illustrates use of directed gravity to manipulate items in the stack area.

FIG. 10 is a schematic block diagram illustrating the components of a portable electronic device that can be implemented with the game application of the present invention, in accordance with one embodiment of the present invention.

FIG. 11 is a schematic illustration of a smartphone that can include the components illustrated in FIG. 10 for play the inventive game.

FIG. 12 is a schematic diagram illustrating the Internet as one embodiment of a network environment in which the inventive game may be deployed.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The detailed descriptions of the system and process of the present invention are presented in terms of schematics, functional components, methods or processes, symbolic or schematic representations of operations, functionalities and features of the invention. These descriptions and representations are the means used by those skilled in the art to most effectively convey the substance of their work to others skilled in the art. A software implemented function, method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated by associated hardware, software and firmware.

Useful devices for performing the software implemented processes, operations and functions of the present invention include, but are not limited to, general or specific purpose digital processing and/or computing devices, which devices may be standalone devices or part of a larger system, portable, handheld or fixed in location. Further, different types of client and server devices can be configured to implement the electronic game application of the present invention. For example, the electronic game application of the present invention may be operable using different types of computing devices, including standalone devices or network client devices. The invention is operational with numerous other general purpose or special purpose computing system environments or configurations. Examples of well-known computing systems, environments, and/or configurations that may be suitable for use with the invention include, but are not limited to, dedicated or general purpose game consoles, personal computers, server computers, hand-held or laptop mobile devices (e.g., notebook computers, PDAs (personal digital assistants), smartphones, tablets, handheld gaming devices, etc.), multiprocessor systems, microprocessor-based systems, set top boxes, programmable consumer electronics, network PCs, minicomputers, mainframe computers, embedded systems, distributed computing environments that include any of the above systems or devices, and the like.

These devices may be selectively activated or configured by a program, routine and/or a sequence of instructions and/or logic stored in the devices to execute the disclosed functions, processes and operations. The game application of the present invention may be described in the general context of computer-executable instructions, such as program modules, being executed by a computer. Generally, program modules include routines, programs, objects, components, data structures, etc. that perform particular tasks or implement particular abstract data types, including networked based (e.g., web-based) systems that runs the game application, system and process described herein below. The invention may also be practiced in distributed computing environments where tasks are performed by remote processing devices that are linked through a communications network or other data transmission medium. In a distributed computing environment, program modules and other data may be located in both local and remote computer storage media including memory storage devices.

In short, use of the processes, functions and operations described and suggested herein is not limited to a particular processing configuration.

For purposes of illustrating the principles of the present invention and not by limitation, the game application of the present invention is described herein below by reference to an exemplary game system. However, it is understood that the present invention is equally applicable to systems of other configurations embodying the invention, without departing from the scope and spirit of the present invention. The present invention will be described herein-below in reference to portable gaming devices. However it is understood that the present invention could be applied to other types of dedicated or general application devices, currently known or future discovered, without departing from the scope and spirit of the present invention.

Overview of Game Device

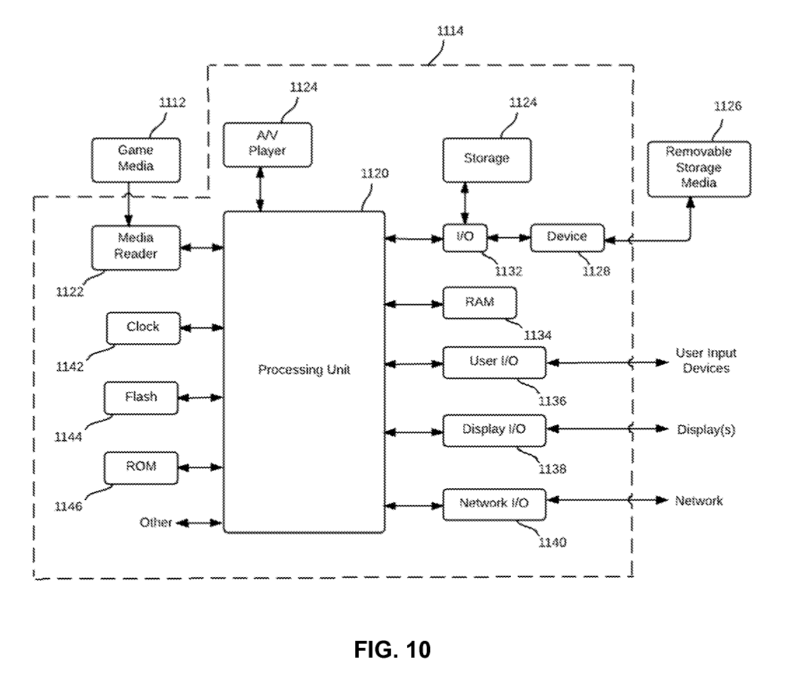

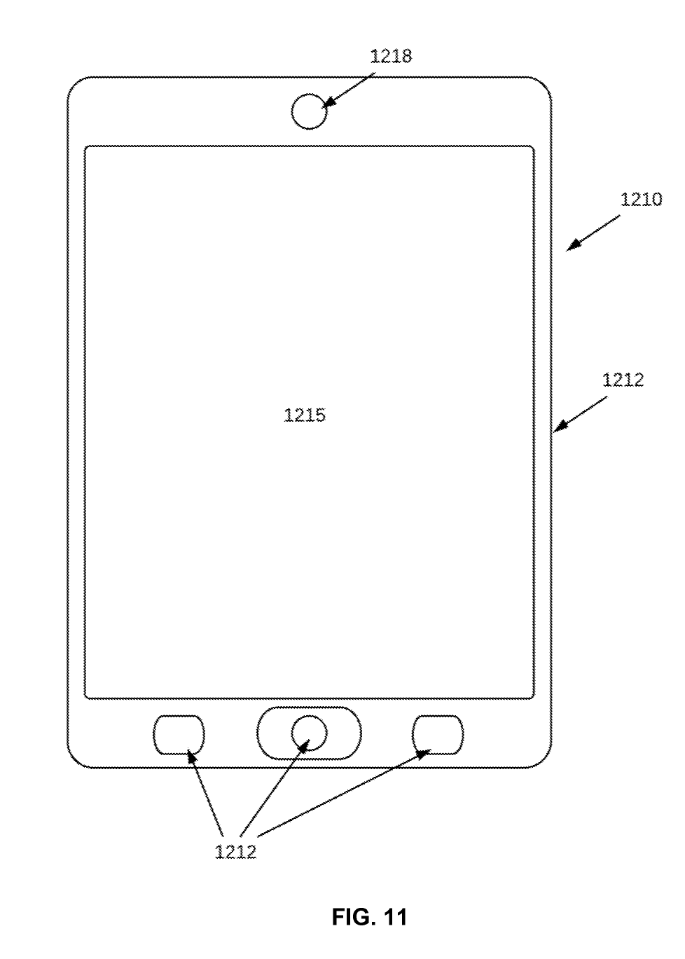

With reference to FIG. 10, an exemplary portable electronic device for implementing the invention provides an electronic game platform (e.g., a game interface and/or game client) according to an embodiment of the present invention. Portable electronic device 1114 is configured to play electronic games according to one embodiment of the present invention. According to illustrated embodiment in FIG. 11, the portable electronic device 1114 can be implemented as a mobile telephone 1210 configured for playing electronic games. One skilled in the art will recognize that other variations of portable electronic device 1114 may be substituted from the examples described herein without departing from the spirit of the present invention. One skilled in the art will also recognize that embodiments of the present invention may be implemented for conventional electronic game platforms, such as electronic game consoles and/or personal computers.

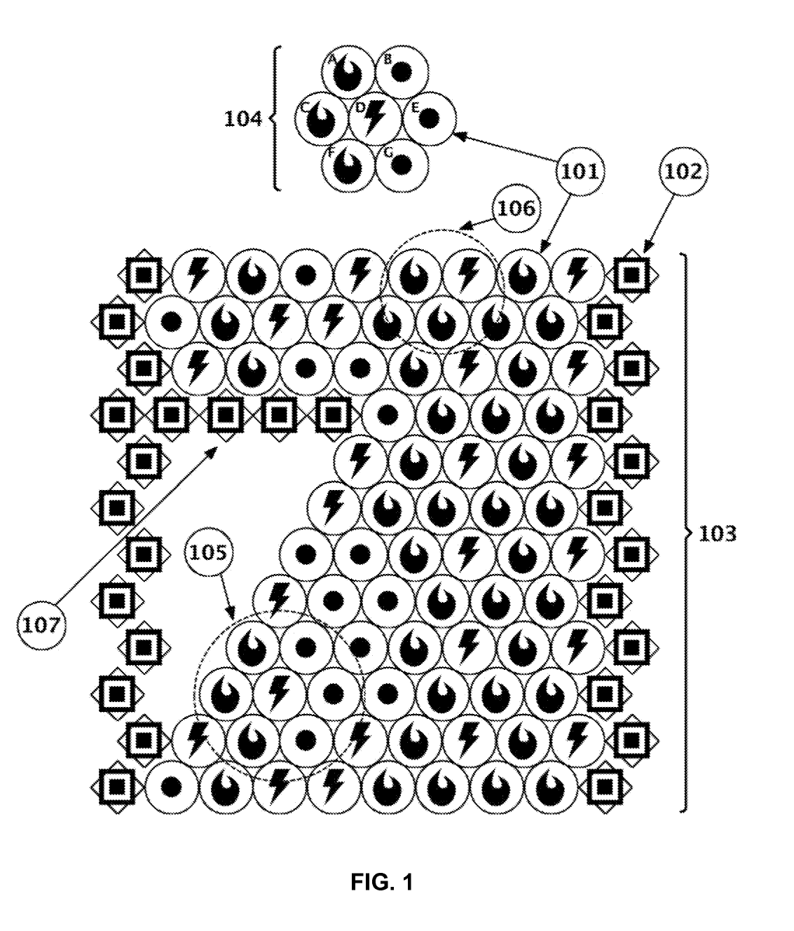

As shown in FIG. 1, portable electronic device 1114 includes a processing unit 1120 that interacts with other components of portable electronic device 1114 and also interacts with external components to portable electronic device 1114. The storage 1124, removable storage media 1126 and/or ROM 1146 in the device may store the game application of the present invention (e.g., in executable code or game state data). Alternatively, portable electronic device 1114 may also optionally comprise a media reader 1122 that communicates with a game media 1112. Game media 1112 may be a persistent memory that stores game software, such as executable program code, configuration data, images, and/or other electronic game content. Game media 1112 may comprise any number of persistent memory storage media such as optical media, cartridges, flash memories (such as a Secure Digital (SD) card), a read-only memory (ROM), and/or other persistent storage medium. Media reader 1122 may be any reader that can receive and read data from game media 1112.

Portable electronic device 1114 also includes various components for enabling input/output, such as I/O 1132, user I/O 1136, display I/O 1138, and network I/O 1140. I/O 1132 interacts with storage 1124 and, through device 1128, removable storage media 1126 in order to provide storage for portable electronic device 1114. Processing unit 1120 communicates through I/O 1132 to store data, such as game state data and/or any shared data files. In addition to storage 1124 and removable storage media 1126, portable electronic device 1114 includes random access memory (RAM) 1134. RAM 1134 may be used for data that is accessed frequently, such as game state data while a game is being played.

Display output signals produced by display I/O 1138 comprising signals for displaying visual content produced by portable electronic device 1114 on a display device, such as graphics, user interfaces, video, and/or other visual content. Portable electric device 1114 may comprise one or more integrated displays configured to receive display output signals produced by display I/O 1138. According to some embodiments, display output signals produced by display I/O 1138 may also be output to one or more display devices external to portable electronic device 1114.

User I/O 1136 is used to send and receive commands between processing unit 1120 and any user input devices, if attached, such as, joystick, mice, game controllers, click-wheel devices, and/or other user input devices. The user devices may, according to some embodiments, be integrated into portable electronic device 1114, while in other embodiments, the user devices may be external to portable electronic device 1114. Display I/O 1138 provides input/output functions that are used to display images from the game being played. The display may be integrated into or external to the portable electronic device 1114. Network I/O 1140 is used for input/output functions for a network. Network I/O 1140 may be used if a game is being played on-line or being accessed on-line.

According to the exemplary embodiment, portable electronic device 114 may be a mobile phone and network I/O provides wireless connectivity to a mobile phone provider's network. Network I/O may also provide Internet connectivity via a wireless connection. Some embodiments may enable players to download game content to portable electronic device 1114 from the mobile phone provider and/or from the Internet. Players may also be able to receive content from a network game server, upload content to the network game server. Players may also share content via the network game server or directly, such as through a Bluetooth connection or other connection between portable electronic device 1114 and another electronic device.

Portable electronic device 1114 may not have network access and therefore may not include network I/O 1140. For example, some portable electronic device, such as a PDA, may download game application software and other data by linking to a host computer via a wired or a wireless connection and downloading the content to the PDA.

Portable electronic device 1114 also includes other features that may be used with a game, such as a clock 1142, flash memory 1144, read-only memory (ROM) 1146, and other components. An audio/video player 1148 is also used to play a video sequence such as a movie.

The embodiments of portable electronic device 1114 described herein are merely exemplary and one skilled in the art will recognize that additional and/or alternative components may be included variations of portable electronic device 1114 according to alternative embodiments.

In operation, the processing unit 1120 operates to run the game application stored in the device 114 or made available to the device 1114 (e.g., from an external source, such as via a network). The processing unit 1120 functions as a controller to interact with and operate (directly or indirectly via other controlled devices) the various components in the device, in accordance with the programmed rules and logics of the game application of the present invention. In particular, the progress of the gameplay is displayed on the internal display 1215 on the smartphone 1210, or via an external display, and the player's selection of items are read and processed to advance the game in accordance with programmed game rules and logics.

Mobile Phone as Game Platform

According to one embodiment of the present invention, the interactive pattern matching game application is provided for play on mobile phones as the game platform, such as illustrated in FIG. 11. While FIG. 11 illustrates a game platform that is a smartphone 1210, however, any mobile platform such as tablets may be used. In one embodiment, the smartphone 1210 includes the components of the portable electronic device 1114 shown in FIG. 10.

In FIG. 11, the smartphone 1210 includes a housing 1212 supporting a display 1215, which renders the images depicted progress of the game, which will be elaborated below. For a smartphone, the display 1215 is typically a touch screen, which accepts user interactive inputs via touch. In other words, in the case of a touch screen, it serves both functions of user input device and user output device. In addition, user interactive buttons and/or keys 1220 are provided on the housing 1212 to allow further user interactive inputs. A speaker 1218 is provided on the housing to provide audio output, which adds further dimension to the game. The display 1215, speaker 1218, keys 1220, etc. are various components having the function described in connection with the portable electronic device 1114 shown in FIG. 10.

While the embodiments described herein make reference to mobile phones as a portable game interface and/or gaming platform, one skilled in the art will recognize that the embodiments described above may also be implemented on other types of portable electronic devices. One skilled in the art will recognize that the embodiments described herein may be adapted for play on conventional electronic game platforms, such as electronic game consoles and/or personal computers.

Overview of Game Area

FIGS. 1 and 3-9 schematically illustrates the screen images (or partial thereof) of the game area as depicted by the display 1215. As seen in FIG. 1, the game area comprises a region referred herein as the stack 103, and a target pattern 104. The stack 103 includes an array of “items” 101, each associated with one of two of more types (flame, lightning bolt and dot). The items are each represented by a graphical icon, which identifies that it belong to a certain type, to differentiate from other items belonging to a different type. There could also be tiles 102 distributed at various locations in the game area. As will be explained later below, once the tiles are provided in the game area, the positions of the tiles 102 are fixed relative to the game area. In contrast, the items 101 are free to move about the game area within constraints of the gameplay (as will be explained further below). As illustrated in the embodiment of FIG. 1, the positions of items 101 are limited to the grid of a matrix corresponding to a staggered array, in which the items are aligned in parallel rows, with the items staggered between two adjacent rows. Between three adjacent rows, seven items can be grouped to correspond to a hexagon pattern (see, e.g., the group of items within the circle 105). Note that the array may be a grid, honeycomb, or other repeating pattern. As will be better understood from the discussion of the gameplay below, the stack 103 is essentially a “working area”, in which items can “flow” under gravity and dynamically position themselves, which can be interactively “selected” and/or manipulated by the player.

The target pattern 104 is a representation of a smaller array (or a subset) of the items 101, having a particular grouping of items in a particular configuration and orientation. In the embodiment of FIG. 1, the target pattern 104 includes seven items arranged in a hexagon array.

FIG. 1 shows the orientation of the display screen, in which the target pattern 104 is fixedly positioned near the top of the screen, and the items 101 within the stack 103 can move from the top towards the bottom of the screen as if under gravity, so that items 101 are stacked from the bottom of the screen as more items 101 are loaded to the stack 103 from the top of the screen.

Overview of Game

The inventive game is directed to interactive pattern matching, requiring the player to recognize the pattern of an array of a group of items 101 within the stack 103 which matches with the displayed pattern of the array of the target pattern 104, in order to be able to remove items from the stack 103. The target pattern 104 changes over time, so the player is provided an opportunity to remove various groups of items 101 from the stack 103 which correspond to the target patterns 104. The object of the game is to remove as many items 101 from the stack 103 as quickly and efficiently as possible.

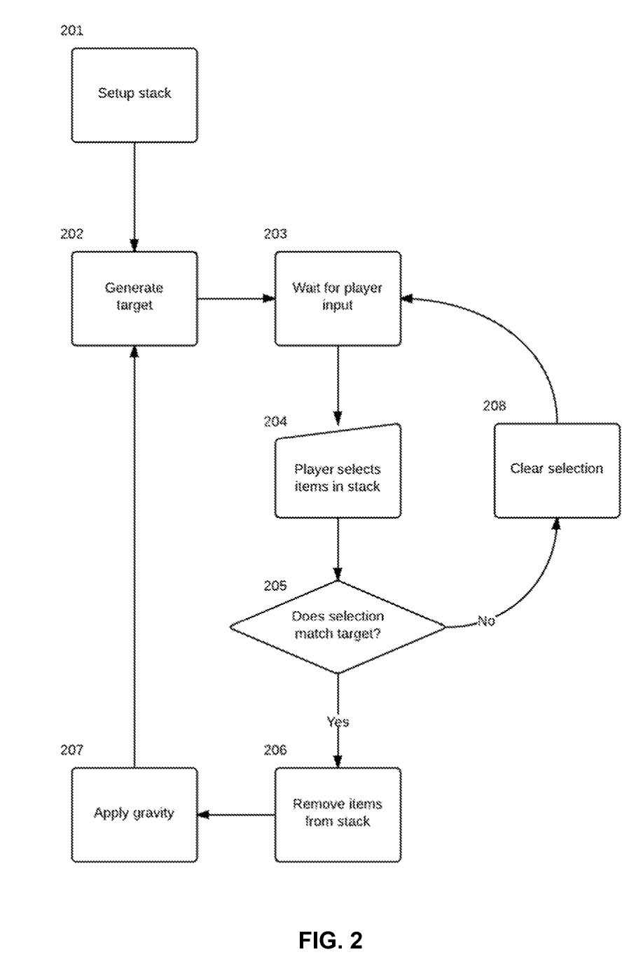

FIG. 2 provides a flow diagram showing the basic steps of the game. At step 201 items are chosen by the game from two or more types and placed or drop into an array that comprises the stack 103. At step 202 the same types of items are then arranged in a smaller array that comprises the target pattern 104.

The choice of item types placed into the stack 103 and target pattern 104 may be predefined or random at steps 201 and 202 respectively, as determined by the game and/or preset by the player prior to the game.

FIG. 1 shows three item types represented by a dot, lightning bolt, and flame, however any number of types may be used with greater difficulty resulting from a higher number of types. Colors, shapes, or both colors and shapes may be used to visually differentiate the item types.

In the preferred embodiment, there are two to seven different item types used for different levels of difficulty. When the target pattern 104 is generated by the game, it can be done in a manner that considers the relative frequency of the different types of items remaining in the stack 103. This helps to ensure that it will be possible for the player to find matches.

At step 203 the player must visually search the stack 103 for a grouping of items 101 having an array matching the array of items in the target pattern 104.

At step 204 the player selects items from the stack that they believe are a match to the target pattern. For example, the seven items at 105 are a perfect match for the target pattern 104 while the three items 106 are a partial match. The player selection of items is further elaborated below.

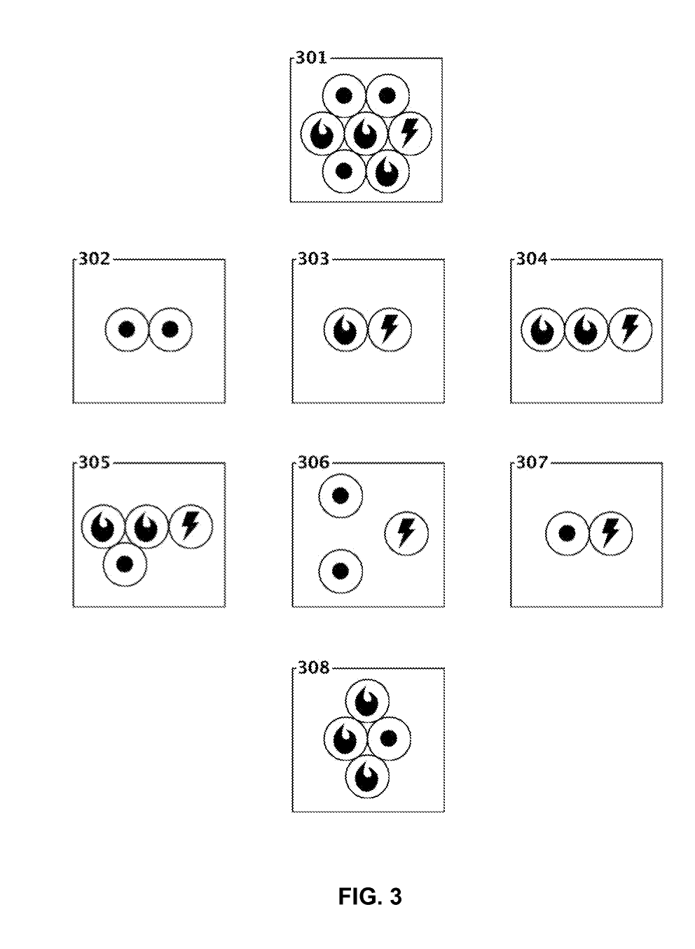

At step 205, the game determines whether the player-selected items are a match for the target. The selected items match the target pattern when the same type of items can be found in the target pattern and in the same configuration relative to one another. FIG. 3 illustrates this concept with some examples. For target pattern 301, Selection 302 is valid as it occurs at the top of the target pattern. Selection 303 is valid as it occurs at the right of the target pattern. Selection 304 is valid as it occurs in the middle row of the target pattern. Selection 305 is valid as it occurs on the bottom/middle of the target pattern. Selection 306 is valid since items need not be contiguous as long as the match occurs in the target pattern. Selection 307 is not valid as nowhere in the target pattern has a dot symbol item to the left of a lightning bolt item. Selection 308 is not valid because although this pattern occurs in the target pattern, it is not in the same orientation as in the selection.

In FIG. 1, two sets of items are shown that match the target pattern 104. The seven items indicated at 105 match all seven items in the target pattern 104 and represent the best possible selection. The three items indicated at 106 are also a match for items C, D and F in target pattern 104. Note that there are many possible partial matches shown in the stack 103. Statistically, the larger the number of items from the target pattern 104 to be considered for a partial match, the less likely it is that it will occur in the stack 103. For example, there are many partial matches where just two items match, while there far fewer where four or more items match and there is only one where all seven items match.

If there is no match between the player-selected items and the target pattern 104, the selected items are cleared at step 208 and the player may try again.

If there is a match, at step 206 the selected items are removed by the game from the stack resulting in empty spaces left behind by the removed items. At step 207, gravity is applied by the game to fill these empty spaces with the items from above them. New items may be added by the game to the stack at this time, dropping in from the top of the stack or alternatively appearing as a new row of items at the bottom of the stack as the entire stack is shifted upward. Then at step 202 a new target is generated again by the game and the process continues.

Objective for Success

The flow diagram in FIG. 2 may repeat indefinitely, with the player deciding when to stop. Alternatively, the game may add conditions for ending the game. One condition for success may be the removal of a set number of items from the stack. When this condition for success is in place, an indicator of the number of items left to be removed may be presented to the player so they can gauge their progress. Alternatively, a scoring scheme may be implemented for the game to award points to the player depending on the level of difficulty of a match, time to accomplish a match, and various other factors to be taken into consideration.

Limiting the Time Available

A condition for failure may be removing items too slowly from the stack. This may be visually conveyed to the player by starting the stack near the bottom of the screen and moving it upward toward the target. If the top item of the stack reaches the failure point near the bottom of the target pattern, the game is over. The pace of movement of items in the game dictates the speed at which items must be selected by the player to be removed from the stack in order to prevent it from reaching the failure point. As items are removed, the items above the removed items fall down, thus giving the player more time before the top of the stack reaches the failure point.

Method of Selecting Items

The primary interaction is step 204, where the player selects items from the stack. This can be done in several ways depending on the game platform (e.g., tapping the items on a touchscreen or clicking the items with a mouse). The player must select items that match the target pattern in order to remove them from the stack.

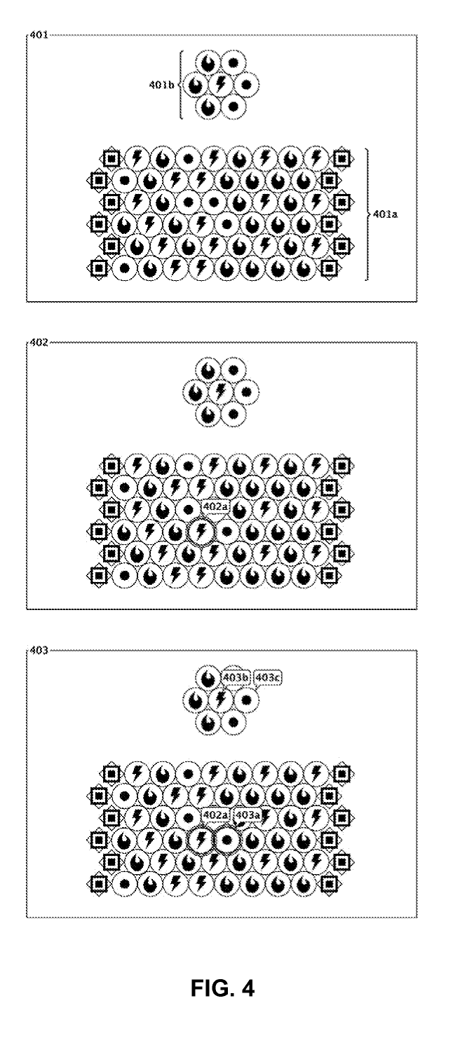

FIG. 4 illustrates the sequence of events for selecting and removing items. At step 401, the stack 401a and target pattern 401b are shown to the player. The player decides to remove a pair of matching items. Step 402 shows the first item 402a visually highlighted after it has been selected by the player. Step 403 shows a second item 403a visually highlighted after it too has been selected by the player. The two selected items 402a and 403a match the items in the target pattern 403b and 403c.

The player may select anywhere from 2 to 7 items and remove them all at once, as long as they match the target pattern. The more items matched at once, the faster the stack can be cleared.

The player may also remove any single item even if it does not occur in the target pattern.

When a group of items have been selected, the player indicates they are done selecting items. This can be done in several ways depending on the target game platform (e.g., clicking/tapping a dedicated “select” button/icon, swiping downward on a touchscreen, right-clicking with a mouse, or simply not selected anything else for a fixed time period of a second or two). When the player is done selecting items, the game proceeds to step 205.

Method for Determining if the Selected Items Match the Target Pattern

Referring again to FIG. 1, the steps for determining if the selected items are a match for the target pattern is as follows. First, the game checks if all of the selected items can be positioned into an array of the same size as the target pattern 104. If the items cannot fit, then the player selection does not match. If they do fit, then the game compares the type of item in each of the filled positions within the array with the same position within the target pattern and if there are no differences than the selection does match. Note that if there is more than one location within an array the same size as the target pattern into which the selected items will fit, then each location is checked for a match by the game. For example, with selection 105, there is only one possible placement that these items can fit into an array the same size as the target pattern and it results in a match. With selection 106, there are three possible placements. The top left item of the selection could be placed at location A, C, or D. In this case, location C results in a match.

Rotation of the Target

The player may interact with the target pattern by rotating it. The ability to rotate the target allows the player to match items in the stack that don't line up to the original orientation of the target pattern.

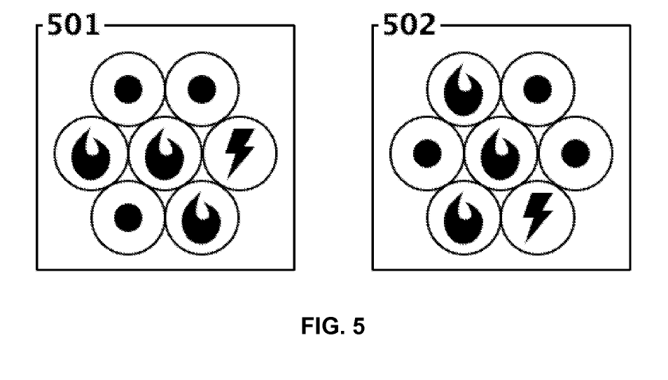

In the case of a honeycomb layout, the 6 outer items of the target pattern rotate around the center item. This can be initiated by the player tapping or clicking on the target or by performing a gesture such as a drag or swipe that originates on the target. The target pattern will rotate in 60-degree increments so that it is always aligned with the grid of the array configuration of the stack. FIG. 5 illustrates the rotation of the target pattern. 501 shows the target pattern before rotation. 502 shows the target pattern after it has been rotated 60-degrees clockwise.

Resetting the Target

In the preferred embodiment, a reset of the target is done automatically at step 202 each time the player removes 2 or more items at a time. The target is not reset if a single item is removed. This allows the player to strategically remove items to match a greater number of items in their next move.

Alternatively, when the player cannot see any matches, they may initiate the generation of a new target pattern. This makes the game easier by allowing the player to change the target pattern to one that is more readily found in the stack. The player may request the game to perform a reset of the target pattern by tapping or clicking on a button.

Other ways of resetting the target pattern automatically by the game include doing so at regular intervals such as every 10 seconds. It can also be done when the game detects (by comparing the content of the stack to the target) that there are few or no matches available for the current target.

Upon a reset by the game, the target pattern generated may be random or it may be built based on the content of the stack.

In the preferred embodiment, it is generated randomly, with the probability of each type of item 101 in the target pattern 104 set according to the number of those types appearing in the stack. For example, if there are 10 red items and 5 yellow items, the probability for each of the 7 positions in the target pattern being red is set to 10 in 15 while the probability for each of the 7 positions being yellow would be 5 in 15.

Tiles

The stack may include tiles 102 that cannot be matched with the target pattern 105 and cannot be selected by the player for removal. The game designer determines the layout of tiles. Since tiles cannot be matched to the target pattern, their inclusion breaks up the stack and makes it harder for the player to match items.

Dragging Items in the Stack

Tiles are not subject to gravity and can serve as platforms and hold up items resulting in empty space below them as shown at 107. These empty spaces can be filled by dragging items sideways into them. The player may drag one or more items at a time toward an empty space, creating an empty space at the source of the drag. Strategic dragging can enable the player to create patterns in the stack that match the target pattern better.

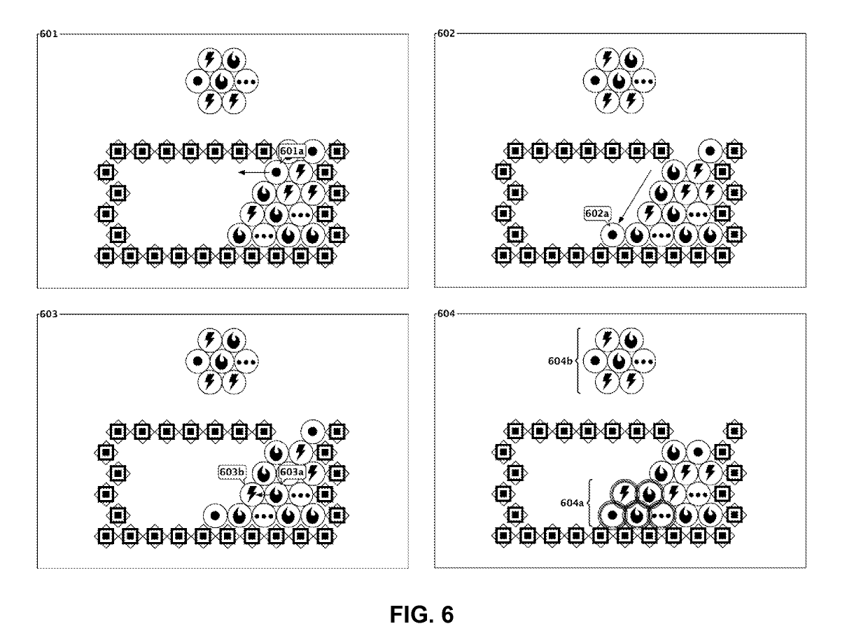

FIG. 6 illustrates this process. In 601, item 601a is dragged by player to the left. In 602 the dragged item drops and lands on the line of tiles at 602a. In 603, item 603a is dragged by player to the left. This has the effect of pushing the item 603b to its left also. In 604 the 5 selected items 604a now match the target pattern 604b. This is a much better match than existed prior to the dragging of the items.

Dragging Items Off the Edge of the Stack

Empty space that is outside the bounds of the stack can be used to allow maneuvering of items when there are no tiles along the edges preventing items from being pushed off the edge of the stack. When items are pushed off the edge of the stack, they fall off the bottom of the screen and are taken out of gameplay.

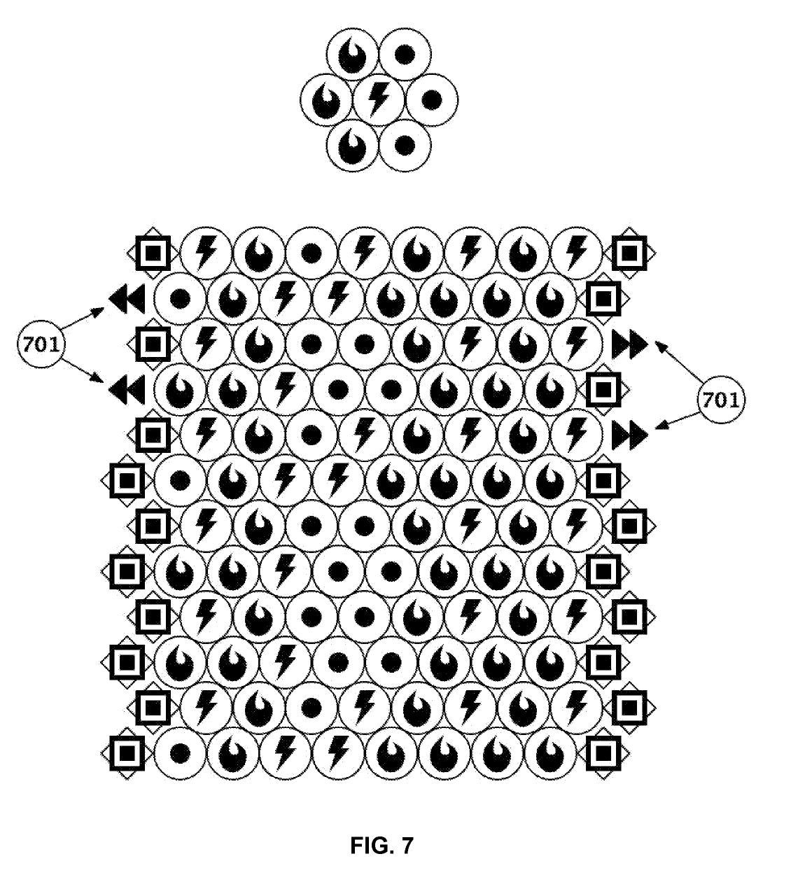

FIG. 7 shows how “holes” in the sides of the stack can be created by not placing tiles continuously along the edge of the screen. These holes are highlighted for the player using arrows 701 to show that items can be pushed out of these holes.

Dragging Entire Rows

In an alternative embodiment, each row of items may be dragged left or right by the player so that when an item goes off the side of the stack, it simply “wraps around” to the other side. For example, if a row of items is dragged right, the rightmost item would appear on the left side once it disappears off the right edge. This enables the player to match items in the target pattern on a row-by-row basis, making it much easier to match many items at once.

For example, the player may find that the first row of the target pattern is on the first row of the stack on the left side. The second row of the target pattern is on the second row in the stack, but on the right side. In this case, the player can simply drag the first row to the right. This enables the player to match 5 items at once (2 from the first row and 3 from the second row) where if he or she did not drag the row only 3 items could be matched at once.

Removal of Single Items

If player removes a single item at a time, the generation of a new target at 202 is skipped. This allows the player to alter the stack to suit their needs for creating a better match to the target pattern.

Rotators

The game designer may include special tiles in the stack the player can interact with. One type of interactive tile is a rotator. When selected, the rotator moves the items around it clockwise. One or more rotators can enable the player to manipulate portions of the stack to create matches to the target pattern that did not previously exist.

Buttons

Buttons are another type of special tile that when selected cause other tiles to temporary disappear and appear again. The tiles that a button controls may be indicated with similar visual cues such as color. The tiles disappearing and appearing can have the effect of letting items in stack drop due to not being supported. This control over tiles can be used by the player to make better matches, particularly when combined with dragging of items in the stack.

Bombs

When the player matches a large number of items at once to the target pattern 104, a bomb may be placed in the stack at the location of the last selected item. The bomb will explode either when selected by the player or after a fixed amount of time. When the bomb explodes, it will remove the items surrounding it. More powerful bombs that remove more items may be created the more items are matched at once. For example, a bomb created by matching 4 items to the target pattern may remove every item directly adjacent to the bomb (up to six items); while a bomb created by matching five items may remove every item within a distance of two items from the bomb (up to 18 items); and so on. If the target pattern 104 contains seven items, then the most powerful bomb would result from matching all 7 items.

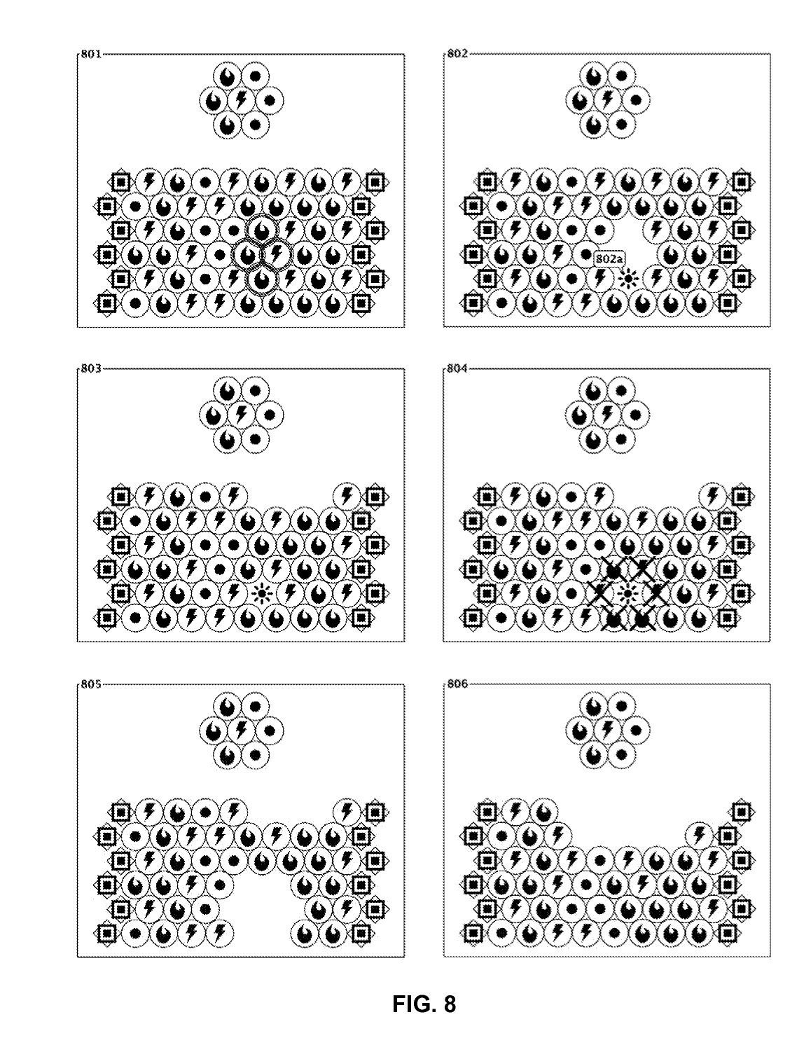

FIG. 8 shows the creation of a bomb and the resulting removal of items when it explodes. In 801 four items matching the target pattern are selected and are about to be removed by the player.

In 802 the 4 items have been removed and a bomb 802a has appeared in the stack. In 803 gravity has been applied and items in the stack have settled around the bomb. 804 shows the items that will be removed when the bomb explodes. In 805 the bomb has exploded and the bomb and its surrounding items have been removed from the stack. 806 shows the stack after gravity has been applied to fill the empty spots.

Missiles

Like bombs, missiles may be awarded to the player when a large number of items are matched at once with more powerful missiles awarded for when more items are matched at once. Unlike bombs however, missiles are not part of the stack and instead appear to the left of the target pattern. The player selects a missile to activate it, then selects where in the stack they want the missile to land. It then “flies” into the stack at the selected position and explodes.

In the preferred embodiment, matching 5 or more items at once creates a bomb that goes off immediately as well as a missile that can be saved for later use.

Goal Items

When bombs and/or missiles are available, another condition for success becomes possible. Special “goal” items that cannot be matched since they do not appear in the target pattern are added to the stack. These goal items must be removed using bombs or missiles to succeed. Goal items that can only be removed by bombs are more challenging for the player.

Directing Gravity

When items fall in the stack at step 207, if the stack is laid out in a grid pattern, with vertical columns and horizontal rows, the item that falls into an empty spot is always the one directly above the empty spot. If the stack is in a honeycomb pattern as shown in FIG. 1, there are two possible locations from which an item may fall. One location is above and to the left of the empty spot and the other location is above and to the right of the empty spot. Which of these locations is used to fill the empty space may be determined randomly or at the direction of the player. This control of gravity can be important for strategy when trying to form patterns of items to match the target.

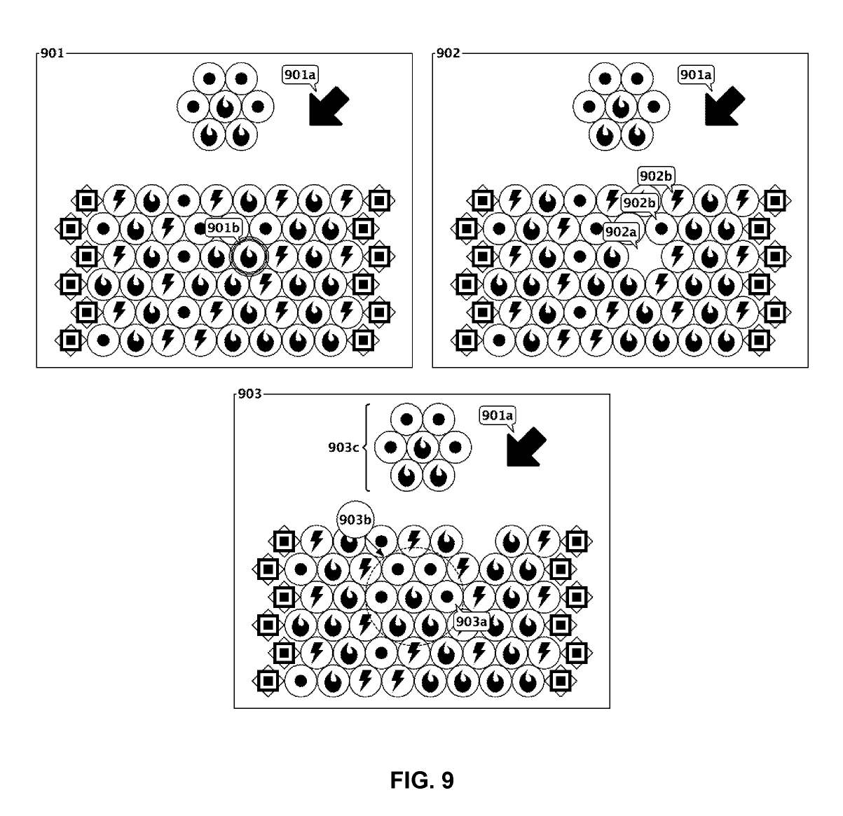

FIG. 9 illustrates use of directed gravity to create a perfect match in the stack. The direction of gravity is indicated by an arrow 901a. The direction of gravity can be changed by the player in different ways depending on the platform (such rotating the orientation of a mobile device or clicking the arrow with a mouse for example). The player removes item 901b, resulting in the empty spot shown at 902a. Since the direction of gravity is set toward the left as indicated by arrow 901a, the items 902b fall and land in the position shown at 903a. This results in the set of items 903b, which perfectly match all seven items in target pattern 903c.

Limiting the Moves Available

Another way to add challenge to the game is to require that the player remove a specific number of items from the stack in a limited number of passes through step 205. For example, if the player must remove 14 items in two passes, that would mean that the player must find two perfect matches. This type of gameplay can be achieved by showing the number of passes through step 205 available to the player as a number labeled as “moves” or “power”. Under these conditions, if the player runs out of moves before removing the required number items, the game is over and the player may try again from a new setup.

When the number of moves available is limited, the player must conserve moves by matching as many items as possible each time items are removed. The number of items removed per move can vary widely depending on how well the player recognizes existing patterns in the stack and/or manipulates the stack and target to create matching patterns.

The efficiency of the player can be measured in items removed per move used.

When the player removes only one item at a time, this results in one item removed per move used. Conversely, matching three items at once results in three items removed per move used. When bombs and missiles are awarded the efficiency goes up on a steeper curve. For example, removing four items at once results in a bomb that can remove an additional six items for an efficiency of ten items removed per move used.

The player can remove greater numbers of items at once by:
Recognizing patterns in the stack.
Rotating the target to match patterns in the stack that would not otherwise work.
Manipulating the stack to create matches for the target pattern by
   Removing single items and directing gravity.
   Removing multiple items and directing gravity (if the embodiment does not reset the target pattern automatically when multiple items are matched).
Dragging items into empty spaces and using gravity to control what falls into the spaces created by dragging as well as where the dragged item falls.
Dragging items out of the stack by dragging them into holes at the edges of the stack and using gravity to control what falls into the spaces created by dragging
Firing missiles at areas where no matches occur.
Using special tiles that affect the stack such as “rotators” and “buttons”.

Levels and Difficulty Progression

The gameplay may be broken up into levels, each consisting of a single stack. Each subsequent level may be of varying difficulty. Alternately, the game may be implemented as a single, “infinite” stack without a fixed number of items to remove where difficulty increases as more items are removed from the stack.

Factors which increase difficulty include:
The number of item types—The more types the less likely it is to find matches and the more confusing visually it is for the player.
The number of items per row—More items per row means it takes longer to clear a row and make progress toward the bottom of the stack. For play on a small screen, such as a mobile phone, the normal range is from five to nine items per row.
The speed at which the stack rises—In the “race against time” mode of play, the stack rises and the rows must be cleared before they reach the top of the game play area. In this mode if tiles are included, they simply disappear when they reach the top of the stack.
The capabilities allowed to the player—To increase difficulty one or more of the following abilities may be disabled: rotation of the target, dragging of items, use of bombs and missiles, and resetting the target pattern.
The number of tiles and their arrangement—Tiles may obstruct making matches or conversely be helpful by creating empty spaces that can be used as a space to drag items into.

Item Variation

To keep the player engaged, the visual representation of the items may be altered throughout the gameplay. The most basic items are essentially solid colored circles, however items can be multi-colored, three-dimensional, or even various animated shapes.

Additional Gameplay Variations

In addition to the core gameplay elements outlined above, several possible enhancements to the game may be included to vary the gameplay and increase the challenge to the player.
Special Items—Items in the stack may have icons on them indicating bonuses that will be given when they are removed. These icons may appear only briefly so that the player must remove the associated items quickly. The bonuses may be bombs, extra points, missiles, extra time, or virtual currency that may be used in the game to buy extra levels or other unlockable content.
Wildcard Items—Wildcard items may be used as a match for any type of item and may appear in either the stack, the target pattern, or both.
Unmatchable Items—Special items can be added to the stack that cannot be matched since they never appear in the target pattern. In some cases, unmatchable items may be selected so they can be removed as single items, or, in other cases, the items must be removed using bombs or missiles. These items can provide an additional level of challenge for more experienced players.
Special Tiles—Tiles in the stack may also be interactive such that selecting them by tapping or clicking causes changes to the stack. Buttons and Rotators described above are two types of special tiles. Others include:
   Teleporters—When an item drops into or is dragged onto a teleporter, it disappears and reappears at another location. The other location may be another teleporter, creating a bi-directional possibility, or it may be just an exit point, limiting travel to just one direction.
   Black Holes—When an item drops into or is dragged onto a black hole, it disappears and is removed from gameplay. This is similar to the effect of a “hole” in the wall at the edge of the stack except that black holes may be placed anywhere in the stack.
   Breakables—Breakables are tiles that can be destroyed leaving an empty space. Different types of breakables break under different circumstances. Some break when they are near to a bomb or missile explosion. Some break only if struck directly by a missile. Some break when they cannot support the number of items above them.
   Antigravity Platforms—Antigravity platforms are tiles that cause the direction of gravity to reverse above them so that items moved above them fall upward instead of downward. Antigravity platforms can be used by a level designer to create an area where items behave differently making it more challenging for the player to create matches to the target pattern.
Bomb Variations—Bombs may be created that remove items based on different patterns other than or in addition to distance from the bomb. Possibilities include: Bombs that eliminate an entire row or other line of items; Bombs that eliminate all the items of a single type; Bombs that go off automatically when the player is about to run out of time. Bombs that allow the player to choose which items should be removed such that the player can choose a fixed number of items to remove or such that the player can choose an unlimited number of items to be removed within a fixed timeframe.
Stack Manipulation Variations—In addition to dragging rows on the stack, it is possible to alter the stack in other ways, such as flipping the stack or just individual rows of the stack such that the items on the left become the items on the right.
Scrolling Levels—In one embodiment, the size of the stack is not limited to the size of the screen. Instead, the stack may be larger than the screen and the player may scroll to different parts of the stack by dragging. In cases where a player's drag action may be interpreted as an intention to drag an item rather than scroll, the dragging of an item would normally take precedence. When a level is larger than the size of the screen, it may be desirable to allow the player to zoom in and out of the stack via a mouse wheel or pinching gesture. Additionally, it may be desirable to provide a view of a scaled down version of the stack where a larger portion or the complete stack may be seen at once.

Player Customizations

Since items can be represented by any graphic, this graphic could be customized by the player. For example, the player may choose photos of their family and friends to appear as items, so that instead of having three different colors to represent three items types, there are three different people. These photos may be chosen from the player's photo gallery on their game device or even taken by the device's camera from within the game application.

Likewise, background images that appear behind the items used in gameplay like wallpaper may be chosen by the player to feature during gameplay instead of using predefined backgrounds.

In multiplayer mode, the background may be replaced by a view of one of the other players (either a still image or video captured by the forward facing camera on the game device of the other player). This live background would allow players to see one another as they compete (or co-operate as the case may be) without needing to look away from the gameplay area.

Multiplayer Mode

The game may be played by multiple players either competitively and co-operatively.

The simplest case of co-operative play is when one game device (e.g., a tablet or other suitable device with a relatively large display screen) is used and multiple players select and remove items. Certain game mechanics are modified to suit this form of play: (1) The target pattern is not reset by the game when a match is made by the players. The target pattern instead resets when no more matches are available, after a fixed amount of time, after a fixed number of matches, or when a player indicates. (2) The mechanism for initiating a match of the selected items affects the group of selected items closest to where the gesture or click mechanism is performed.

Co-operative play with more than one game device works in a similar manner as on a single device except that the same screen output is shown on two devices. One device, the “slave”, functions simply as a duplicate display of the other device, the “master” which handles all gameplay logic and interprets player actions. In this case, a network is used to keep the devices in synchronization. For example positional and status information about each of the gameplay objects can be sent from the master to the slave for rendering and when a player interacts with the slave, the interactions can be sent from the slave to the master for processing.

Competitive play may be done with both players playing at the same time or separately at different times. If playing at different times, both players are presented with the same starting parameters (level layout and item configurations) and the results of their play (score, time to complete, number of items removed, etcetera) are sent either to a central server or to the other player's device so the results can be compared after both players have completed the level.

Simultaneous competitive play is preferably done using two devices communicating wirelessly with each other (e.g., via wifi, Bluetooth, etc., or via a network).

Simultaneous competitive play can be done such that each player sees the same stack and each player's actions affect the stack of the other player also. This means that if player 1 is trying to make a match that player 2 also sees, player 2 may complete the match before player 1, getting the points for making the match and removing the items so that player 1 cannot remove them.

Alternatively, simultaneous competitive play may be done such that each player sees the same starting stack but their actions do not affect the stacks of the other players. In this mode, each player has the same opportunities and whoever can make the better matches faster will increase their score accordingly. In timed levels where the stack rises, the top row of the stack will go down each time a player clears the number of items held on that row. The number of rows cleared can function as the player's position in a virtual race with the other players. For example, if player 1 has cleared 5 rows but player 2 has cleared only 4, player 1 is 1 position ahead of player 2. This can be visually indicated on each player's screen by placing an avatar of the other player on the screen either above the top row (when the other player is behind) or below the top row (when the other player is ahead). If players are tied, their avatars will be on each other's top row. If a player is two rows ahead, their avatar would appear 2 rows below the top row on the other player's screen. The game may be won by the first player to clear a fixed number of rows, the first player to get a fixed number of rows ahead of the other player, or by the player that has cleared the most items when a fixed amount of time has passed.

Note that multiplayer mode may involve 2 or more people.

Computing Environment Including Information Exchange Network

Instead of playing the game using a game application stored local on a player's device, the game may be configured to be play via a network. In the network version of the game, it may be play using a browser, or a thin client interface application (e.g., a player) residing at the player's device (e.g., a tablet). The network version is particularly suited for playing the game in multiplayer mode.

A network for implementing the game in accordance with the present invention using a client device may involve, without limitation, distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

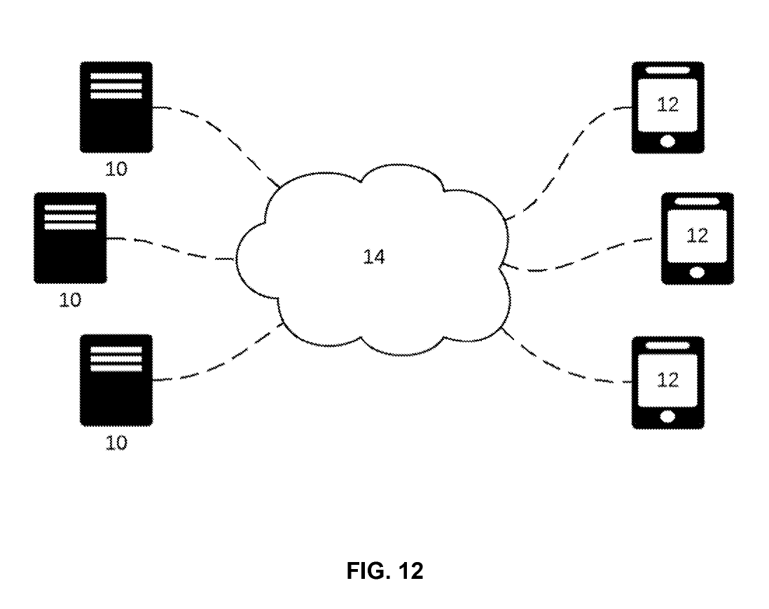

The Internet is an example of an information exchange network including a computer network in which the present invention may be implemented, as illustrated schematically in FIG. 12. Many servers 10 are connected to many clients 12 (which may be desktop, portable and/or handheld devices, including the smartphone device 1210 in FIG. 11) via the Internet network 14, which comprises a large number of connected information networks that act as a coordinated whole. Details of various hardware and software components (such as servers, routers, gateways, etc.) comprising the Internet network 14 are not shown as they are well known in the art. Access to the Internet by the servers 10 and clients 12 may be via suitable transmission media, such as Ethernet, satellite, telephone wires, wireless RF links, Wifi, Bluetooth, or the like, and user interface tools, such as browsers, implemented therein. Communication between the servers and the clients takes place by means of an established protocol. The game application of the present invention may be configured in or as one or more of the servers 10, which is accessible by a player via one or more of the clients 12 (e.g., a smartphone 1210).

The process and device for implementing the inventive interactive pattern matching game application of present invention has been described above in terms of functional modules in block diagram format. It is understood that unless otherwise stated to the contrary herein, one or more functions may be integrated in a single physical device and/or software module in a software product, or one or more functions may be implemented in separate physical devices and/or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the gameplay, system attributes, functionality and inter-relationship of the various functional modules, hardware and software components in the system. A person skilled in the art, applying ordinary skill can practice the present invention without undue experimentation.

While the present invention has been described above in connection with the illustrated embodiments, the scope of patent invention covers all possible present and future variations and improvements that are apparent from the disclosure above. While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

1. A method of playing an interactive game of pattern matching, comprising:
providing a game device, which has a display screen, and a processing unit running a game application and rendering images on the display screen in accordance with requirements of the game application;
rendering an image of a target pattern of items in a designated area of the display screen and an array of items in a stack area of the display screen in accordance with the game application, wherein the items are of at least two types;
selecting a pattern by a player, wherein the pattern corresponds to a group of items in the stack area;
determining whether the selected pattern matches at least part of the target pattern,
if a match is determined, removing the group of items of the selected pattern from the stack area, and
if a match is not determined, keeping the items of the selected pattern within the stack area.

2. The method of claim 1, wherein a match is determined when the items in the selected pattern match corresponding items in the at least part of the target pattern.

3. The method of claim 2, wherein a match is determined if the type and orientation of the items in the selected pattern match the correspond items in the at least part of the target pattern.

4. The method of claim 1, wherein after an item has been removed, a space is left behind in the stack, which allows another item in the stack from above the space to drop into the space after previous item has been removed.

5. The method of claim 1, wherein the array of items in the stack area do not completely fill the entire stack area, allowing the player to selectively manipulate an item into a space not filled with item.

6. The method of claim 1, wherein the target pattern may be rotated to change its orientation.

7. The method of claim 1, further comprising rendering tiles in accordance with the game application, wherein the tiles provides a barrier against movement of the items in the stack area.

8. The method of claim 7, wherein at least one tile can be activated to effect movement of items within the stack area.

9. The method of claim 1, wherein the array of items in the stack area is arranged in staggered parallel rows.

10. A method of playing an interactive game matching game, comprising:
providing a game device, which has a display screen, and a processing unit running a game application and rendering images on the display screen in accordance with requirements of the game application;
rendering an image of a gameplay area including an array of items onto the display screen in accordance with the game application, wherein the items are of at least two types wherein the items of each type are represented by different graphics, each of which can be customized by the player.

11. The method of claim 10, wherein the background image shown behind the array of items can be customized by a player.

12. The method of claim 1, wherein the game application includes a multiplayer mode, in which more than one player can play the game in cooperative play or competitive play.

13. The method of claim 12, wherein a first player selects a first pattern corresponding to a first group of items in the stack area, and a second player selects a second pattern corresponding to a second group of items in the stack area.

14. The method of claim 13, wherein the first player selects the first pattern and the second player selects the second pattern using the same game device.

15. The method of claim 13, wherein the game device comprises first and second game devices, wherein the first player selects the first pattern using the first game device, and the second player selects the second pattern using the second game device.

16. The method of claim 15, wherein the first and second game devices depict the same target pattern and same stack area.

17. The method of claim 15, wherein the first and second game devices depict same starting target pattern and same starting stack area, and wherein action by the first player affects the stack area depicted at the second game device, and vice versa.

18. The method of claim 15, wherein the first and second game devices depict same starting target pattern and same starting stack area, and wherein action by the first player does not affect the stack area depicted at the second game device, and vice versa.

19. The method of claim 15, wherein the first game device and the second game device communicate via a network.

20. An interactive electronic game device, comprising:
a display screen;
a processing unit running a game application, and rendering images on the display screen in accordance with requirements of the game application, wherein the game application is configured to require:
rendering an image of a target pattern of items in a designated area of the display screen and an array of items in a stack area of the display screen, wherein the items are of at least two types.
determining a selected pattern corresponding to a group of items in the stack area selected by a player,
determining whether the items of the selected pattern match corresponding items of at least part of the target pattern, and if a match is determined, removing the items of the selected pattern from the stack area, and if a match is not determined, keeping the items of the selected pattern within the stack area; and
a user input device for a player to use to select items displayed on the display screen.
